(19) United States
(12) Patent Application Publication
(10) Pub. No.: US 2002/0126328 A1
(43) Pub. Date: Sep. 12, 2002

(54) Method and apparatus for matching color image data with a corresponding color in a defined color space

(76) Inventors: Michelle R. Lehmeier, Loveland, CO (US); Michelle Watson, Loveland, CO (US)

Correspondence Address: HEWLETT-PACKARD COMPANY, Intellectual Property Administration, P. O. Box 272400, Fort Collins, CO, 80527-2400, US

(21) Appl. No.: 09/803,441

(22) Filed: Mar. 9, 2001

(51) Int. Cl. B41J 1/00; G06F 15/00

(52) U.S. Cl. 358/518; 358/1.9

(57) ABSTRACT

A system and method for matching a color with a corresponding color in a defined color space scans an object having the color to be matched and produces a color image data signal that is representative of the object, maps the color image data signal to the defined color space to find the corresponding color, and informs a user of the corresponding color.

### FIELD OF INVENTION

This invention relates generally to color optical scanner devices and more specifically to a method and apparatus for matching color image data with a corresponding color in a defined color space with a flatbed scanner device.

### BACKGROUND

Color optical scanners, such as flatbed scanners, are well-known in the art and produce machine-readable color image data signals that are representative of a scanned object, such as a photograph or a page of printed text. In a typical scanner application, the color image data signals produced by a scanner may be used by a computer system (e.g., a personal computer) to reproduce an image of the scanned object on a suitable display device, such as a cathode ray tube (“CRT”) or liquid crystal display (“LCD”). Alternatively, the computer system may print the image of the scanned object on a printer connected to the computer system.

A typical flatbed scanner may include illumination and optical systems to accomplish the scanning of the object. More specifically, the illumination system illuminates a portion of the object (commonly referred to as a “scan region”), whereas the optical system collects light reflected by the illuminated scan region and focuses a small area of the illuminated scan region (commonly referred to as a “scan line”) onto the surface of a photosensitive detector positioned within the scanner housing. Image data representative of the entire object may then be obtained by sweeping the scan line across the entire object, usually by moving the illumination and optical systems relative to the object. Alternatively, the object may be moved with respect to the illumination and optical assemblies.

By way of example, the illumination system may include a light source (e.g., a fluorescent or incandescent lamp or an array of light emitting diodes (LEDs)). The optical system may include a lens and/or mirror assembly to focus the image of the illuminated scan line onto the surface of the detector. Alternatively, a “contact image sensor” (CIS) may be used to collect and focus light from the illuminated scan region on the detector.

The photosensitive detector used to detect the image light focused thereon by the optical system may be a charge-coupled device (CCD), although other devices may be used. A typical CCD may comprise an array of individual cells or “pixels,” each of which collects or builds-up an electrical charge in response to exposure to light. Since the quantity of the accumulated electrical charge in any given cell or pixel is related to the intensity and duration of the light exposure, a CCD may be used to detect light and dark spots on an image focused thereon.

Color optical scanners usually operate by collecting multiple color component images of the object being scanned. For example, data representative of red, green, and blue color components of the image light may be produced by the scanner apparatus. The particular color components, e.g., red, green, and blue, are commonly referred to as primary colors, primary stimuli, or simply, primaries. As is well-known, various combinations of three such primary colors can be used to produce any color stimulus contained within the gamut of colors on the CIE chromaticity diagram that lie within a triangle defined by the primaries. The amounts of each primary color required to match a particular color stimulus are referred to herein as tristimulus values. Written mathematically:

C≡r(R)+g(G)+b(B)

Put in other words, a given color stimulus C (e.g., the color of a given pixel) can be matched by r units of primary stimulus R (red), g units of primary stimulus G (green), and b units of primary stimulus B (blue). All the different physical stimuli that look the same as the given color stimulus C will have the same three tristimulus values r, g, and b. Thus, it is possible to match a color stimulus by a mixture of three primary colors or stimuli, with the tristimulus values r, g, and b determining the required amount of each primary color. It is important to keep in mind that the foregoing method will only achieve psychophysical color match (i.e., the color will appear the same to the human eye), as opposed to a physical or spectral match.

Many different techniques may be used to collect the data representative of the multiple color component images (i.e., the tristimulus values) of the object being scanned. One technique is to project the image of the illuminated scan line onto a single linear detector array. However, in order to collect the multiple color component images (i.e., the tristimulus values) of the illuminated scan line a different color light source (a primary) is used to illuminate the scan line on each of three successive scans. For example, the object may first be scanned using only red light, then only green light, and finally only blue light. The output signal from the detector for each color thus represents the tristimulus value for that color. In a variation of this technique, three scanning passes may be made using a white light source, but the image light from each scan is filtered by a different color filter before being focused onto the optical detector array. Either way, the tristimulus values for the primaries (i.e., the red, green, and blue colors) may be determined from the output signals from the detector.

Regardless of the particular technique that is used in the color optical scanner to collect the tristimulus values, color optical scanners and the personal computers to which they may be connected continue to decrease in price while increasing in quality. Similarly, other computer peripheral devices (e.g., modems) are also decreasing in price. Consequently, more people find themselves with home computer systems that include both scanners and modems and are using those home computer systems to connect to the Internet.

Once connected to the Internet, the variety of things people can do online is far too numerous to fully list herein, especially when considering that new Internet uses are being discovered continuously. One such example, however, is online shopping. Virtually any product available in stores can now be purchased online. For instance, many consumers now use the Internet to shop for, among other things, clothing.

To purchase clothing online, the consumer must usually select the style, size and color for the garment. Although many customers are completely satisfied with their online purchases, many problems may and often do arise when the customer attempts to purchase a certain colored item that will match an item the customer already owns. For example, the customer may want to purchase a blue shirt that will match or go with a blue pair of pants the customer previously purchased. Often times, however, the product's color as selected by the customer will not match the color of the item that the customer already owns.

There are many things that may cause the color mismatch. For example, the lighting in which the product is displayed may be different than the lighting in which the customer observed the object having the color for which a match is sought. The customer's computer monitor may not be properly adjusted thereby causing the color of the desired product to appear differently than it should. Texture on the desired product and/or the object whose color the customer is attempting to match may also cause the customer to select a mismatched color. Regardless of the reason why the color mismatch occurred, the customer is faced with the undesirable choice of either keeping the color mismatched product or returning/exchanging it. Even if the customer is able to successfully return or exchange the product, the customer can usually only do so after expending considerable amounts of time and money (e.g., for shipping costs). In the meantime, the purpose or event for which the product was purchased (e.g., birthday) may have already passed. Ultimately, the customer ends up frustrated and upset.

The difficulty of and problems associated with obtaining a color match, however, are in no way limited to online shopping for clothing. Indeed, color matching is an extremely important task in many other situations. For example, selecting a paint color that matches the color of a room being painted can be a tedious task often requiring more than one trip to the hardware store before the exact match is obtained. Similarly, selecting a curtain color that matches a sofa's color can be equally trying. Although these are but a few of the numerous examples in which the matching of colors is significant, one can easily surmise that matching colors can be a most trying and frustrating experience.

### SUMMARY OF THE INVENTION

Accordingly, a need remains for a color matching system that improves user success rate and satisfaction when matching colors. Ideally, the color matching system would be easy to use with currently available flatbed scanners and computers.

A method for matching a color with a corresponding color in a defined color space includes the following steps: scanning an object having the color to be matched to produce a color image data signal that is representative of the object; mapping the color image data signal to the defined color space to find the corresponding color; and informing a user of the corresponding color.

Also disclosed is a system for matching a color with a corresponding color in a defined color space that comprises scanning apparatus for scanning an object and producing a color image data signal that is representative of the object. A computer operatively associated with the scanner apparatus maps the color image data signal to the defined color space to ascertain the corresponding color and then informs a user of the corresponding color.

### BRIEF DESCRIPTION OF THE DRAWINGS

Illustrative and presently preferred embodiments of the invention are shown in the accompanying drawing in which:

FIG. 1 is a pictorial representation of one embodiment of a color matching system according to one embodiment of the present invention;

FIG. 2 is a flowchart representation of a method for matching a color to a corresponding color in a defined color space according to one embodiment of the present invention;

FIG. 3 is a block diagram representation of the components of apparatus that performs one or more steps of the method shown in FIG. 2;

FIG. 4 is a plan view of a screen display which might be presented to a computer user using the color matching system illustrated in FIG. 1 or the method illustrated in FIG. 2;

FIG. 5 is a plan view of another screen display which might be presented to a computer user using the color matching system illustrated in FIG. 1 or the method illustrated in FIG. 2;

FIG. 6 is a perspective view of a color look-up table;

FIG. 7 is a flowchart representation of the color mapping step of the method illustrated in FIG. 2 according to one embodiment of the present invention; and

FIG. 8 is another flowchart representation of the color mapping step of the method illustrated in FIG. 2 according to an alternative embodiment of the present invention.

### DETAILED DESCRIPTION OF THE INVENTION

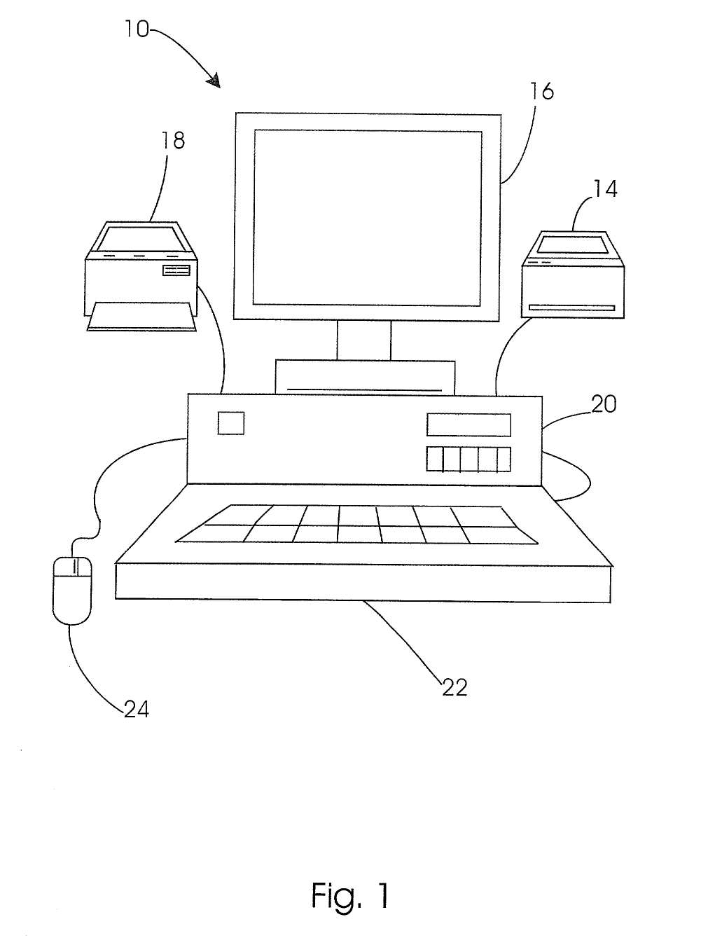

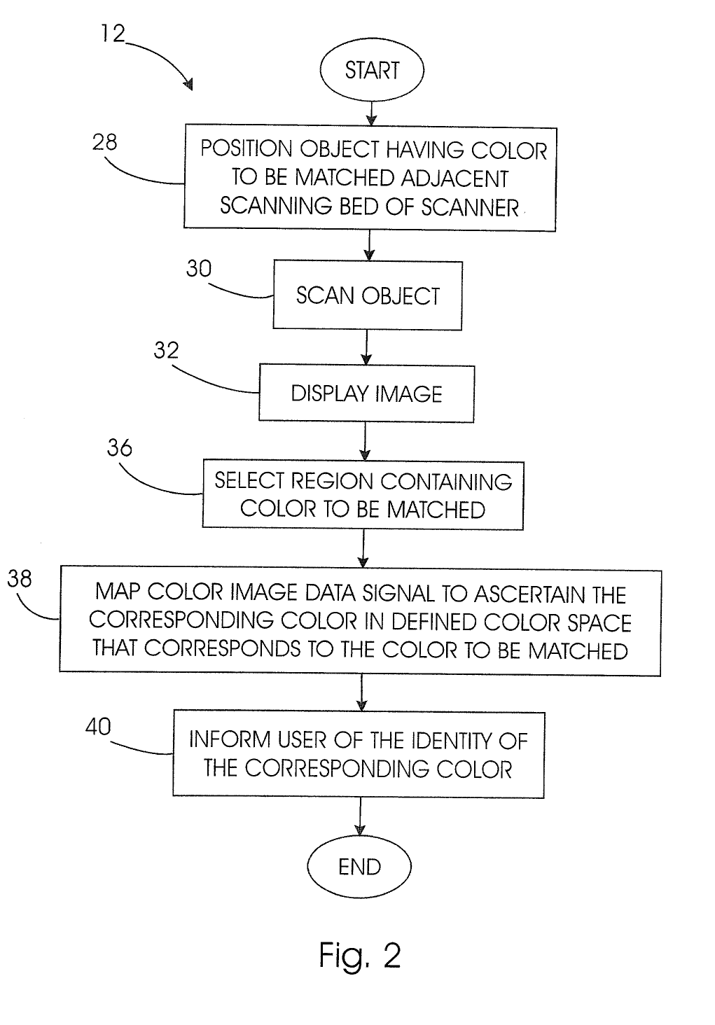

The present invention comprises both an apparatus 10 and a method 12 for matching a color with a corresponding color in a defined color space. The apparatus 10 (i.e., color mapping system) is shown in FIG. 1, whereas the method 12 is illustrated in FIG. 2. Although the present invention is described herein as it could be used in conjunction with a flatbed scanner 14, the present invention, as will be described in greater detail below, may be used in conjunction with any of a wide range of other optical scanner apparatus.

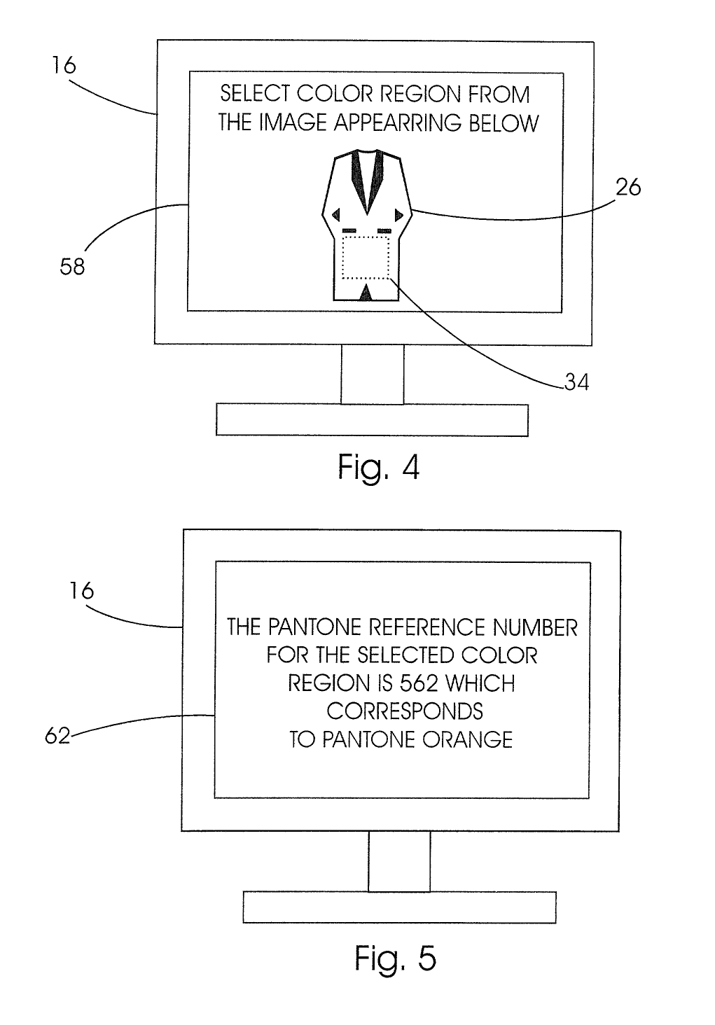

The apparatus or computer system 10 that performs the method 12 may comprise a flatbed scanner 14. See FIG. 1. The apparatus 10 may further include a monitor 16, a printer 18, a processing unit 20, a keyboard 22, and a mouse 24. The apparatus 10 may be provided with image processing software (not shown) which allows the apparatus 10 to display an image 26 (FIG. 4) of a scanned object on the monitor 16. The computer system 10 may also print an image (not shown) of the object on the printer 18.

As shown in FIG. 2, the method 10 generally comprises the following steps. In the first step 28, the object having the color to be matched is positioned adjacent a scanning bed of the flatbed scanner 14. The flatbed scanner 14 is actuated at step 30 to scan the object and to produce a color image data signal representative of the object. The color image data signal may then be transferred to the processing unit 20 of the computer system 10 so that an image 26 of the scanned object may be displayed on the monitor 16 at step 32. See FIG. 4. Next, a color region 34 containing the color to be matched may be selected at step 36. Once selected, the computer system 10 maps the color image data signal (step 38) to ascertain a corresponding color in a defined color space (e.g., Pantone Matching System) that corresponds to the color to be matched. In the final step 40, the user is informed of the identity of the corresponding color. For example, the user may be provided with a reference number that identifies or is associated with the corresponding color.

A significant advantage of the present invention is that it improves consumer success rate and satisfaction when matching colors. Since the corresponding color identifies the color for which a match is sought, the consumer will no longer be required to visibly match and select the appropriate color and will instead just select the color that corresponds to the corresponding color. Indeed, if the user is provided with a reference number associated with the corresponding color, the user can simply select the color corresponding to the reference number. Thus, the color matching difficulties associated with such things as different lighting conditions, computer monitor settings, etc., are eliminated.

Another significant advantage of the present invention is that it is easy to use since all the user has to do is scan the object that contains the color to be matched. Indeed, the present invention can be used with currently available flatbed scanners and computers.

Yet another significant advantage of the present invention is that along with the improvements in color selection accuracy the invention tends to increase consumer confidence. For instance, customers shopping online may be less concerned about mismatching product colors since the customers should be able to select the correct color by simply providing the identity of the corresponding color or its reference number. Indeed, by using the present invention, vendors of all sorts should be able to custom make products in the exact color requested by the consumer.

Having briefly described the apparatus 10 and the method 12 according to one embodiment of the present invention, as well as some of their more significant features and advantages, the apparatus 10 and method 12 will now be described in detail. However, before proceeding with the description, it should be noted that although the apparatus 10 and method 12 are shown and described herein as they could be used in conjunction with a flatbed scanner 14, they could also be used in conjunction with any of a wide range of other optical scanner apparatus. For instance, the apparatus 10 or method 12 both could be used in conjunction with a digital camera. Consequently, the present invention should not be regarded as limited to use in conjunction with the flatbed scanner 14 shown and described herein.

With the foregoing considerations in mind, the apparatus 10 and method 12 according to one embodiment of the present invention are both shown and described herein as they could be used in conjunction with a flatbed scanner 14, of the type that is readily commercially available and well-known in the art. However, since flatbed scanners are well-known in the art and could readily be provided by persons having ordinary skill in the art after having become familiar with the teachings of the present invention, the various component parts of the flatbed scanner 14 will not be discussed in further detail herein.

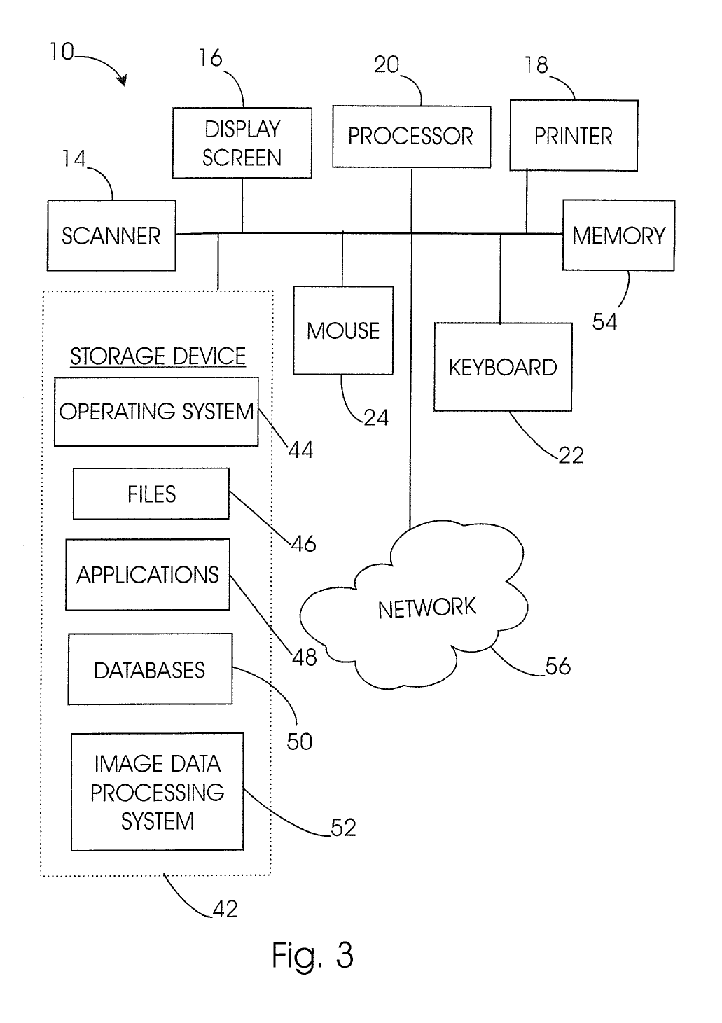

As shown in FIGS. 1 and 3, the flatbed scanner 14 may be connected to a computer system or apparatus 10 that includes a monitor 16, a printer 18, a processing unit 20, a keyboard 22, and a mouse 24. The computer system 10 may be provided with image processing software (not shown) which allows the computer system 10 to display an image 26 (FIG. 4) of the scanned object on a suitable display device 16, such as a CRT or LCD display. The computer system 10 may also print an image (not shown) of the scanned object on the printer 18.

FIG. 3 shows the various hardware and software components of the apparatus 10 that perform the method 12. The apparatus 10 may comprise a processor or central processing unit (CPU) 20, input devices (e.g., scanner 14, keyboard 22, mouse 24) and output devices (e.g., monitor 16, printer 18). The apparatus 10 may further include a storage device 42 having an operating system 44, files 46, applications 48, databases 50 and an image data processing system 52 stored therein. The operating system 44, once installed, may manage the various tasks, jobs, data and devices of the computer system 10. The apparatus 10 may further include a memory 54 which the operating system 44 may access in carrying out its functions. Contained within a computer readable storage device such as storage device 42 or memory 54 may be computer readable program code for performing or carrying out one or more of the various steps of method 12, which steps were discussed briefly above and are discussed in much greater detail below. The CPU 20 may be linked over a network 56 (e.g., a Wide Area Network (WAN), a Local Area Network (LAN), an Intranet, or the Internet) to a server or pool of servers (not shown).

It is understood that the CPU 20 may comprise any of a wide range of suitable processors, as would be obvious to persons having ordinary skill in the art after having become familiar with the teachings of the present invention. For example, the CPU 20 may comprise an Intel PENTIUM® processor, an entire laptop or desktop personal computer (PC), or an application specific integrated circuit (ASIC) specifically manufactured for use with the present invention. Likewise, the storage device 42 and memory 54 can be any suitable computer readable storage device, such as read only memory (ROM), random access memory (RAM), video memory (VRAM), hard disk, floppy diskette, compact disc (CD), magnetic tape, a combination thereof, etc. Further, the CPU 20 and memory 54 need not be separate units and can be combined, or alternatively, the CPU 20 and memory 54 can be separately housed and linked to one another over a remote network or other suitable connection. In addition, there can be any number of CPUs 20 (i.e., one or more), any number of storage devices 42 (i.e., one or more) and/or any number of memories 54 (i.e., one or more) that are connected or linked via the Internet, Intranet, LAN, WAN, etc. In such a scenario, the storage of computer readable program code may be distributed over the various storage devices 42 and memories 54 and/or executed in parts by the various CPUs 20. Moreover, any number of suitable peripheral devices (e.g., scanner 14, monitor 16, printer 18, keyboard 22, mouse 24, etc.) may be connected to the CPU 20 either directly or indirectly (e.g., over the network 56). The CPU 20 can be linked to the network 56 using any suitable connection (e.g., modem, T-1, digital subscriber line (DSL), infrared, etc.).

Within the storage device 42 of apparatus 10 may be an image data processing system 52 that is operatively associated with the flatbed scanner 14. The image data processing system 52 may perform one or more of the various steps comprising the method 12. More specifically, the image data processing system 52 may process the raw color image data signal (not shown) produced by the flatbed scanner 14 so that an image 26 of the scanned object may be displayed at step 32. See FIGS. 2 and 4.

In the embodiment shown and described herein, the image data processing functions occur within the processor 20 of the computer system 10. For example, computer programmable code (e.g., image data processing software) may be provided that carries out the various image data processing functions. The program code may be contained within a computer readable storage device, such as storage device 42 or memory 54, and be operated on the processor 20. Alternatively, the image data processing system 52 may be built into or reside in the housing of flatbed scanner 14. In other words, the flatbed scanner 14 may include the image data processing system 52 so that the processing of the raw color image data signals produced by the scanning device occurs within the flatbed scanner 14. In an alternative embodiment, a device (not shown) specially designed (e.g., “hard wired”) may be provided that is operatively associated with the scanner 14 and apparatus 10. The specially designed device may process the color image data signal. In yet another alternative embodiment, the image data processing functions may be split between the flatbed scanner 14 and the CPU 20 of the computer system 10 with each performing portions of the processing functions. In any event, a suitable arrangement for the image data processing system 52 may be easily arrived at by persons having ordinary skill in the art after considering the requirements for the particular application and after becoming familiar with the teachings of the present invention.

The image data processing system 52 may comprise any of a wide range of image data processing systems that are well-known in the art. Accordingly, the present invention should not be regarded as limited to any particular type of image data processing system. Moreover, since image data processing systems are well-known in the art and the details of image data processing systems themselves are not necessary to understand the present invention, the particular image data processing system utilized in one preferred embodiment of the present invention will not be described in further detail herein.

Regardless of the type of image data processing system that is utilized, if any portion of the image data processing system 52 is built into or resides in the housing of flatbed scanner 14, it is generally desirable to provide the image data processing system 52 with one or more communication ports (not shown) to allow data to be transferred or “downloaded” to the CPU 20. While any of a wide range of well-known communication ports and formats may be utilized, in one preferred embodiment, the image data processing system 52 may be provided with a universal serial bus (USB) port (not shown) and/or an infra red (IR) serial port (also not shown). The USB port and/or IR serial port may be located on the scanner housing at any convenient location.

As discussed briefly above, FIG. 2 shows the various steps comprising the method 12 for matching a color with a corresponding color in a defined or known color space. It is to be understood, however, that the steps shown in FIG. 2 need not be performed in the particular order shown therein. In other words, the arrangement shown in FIG. 2, as are the arrangements shown in FIGS. 1 and 3-6, is merely illustrative and not intended to limit the teachings of the present invention.

In the first step 28, the object having the color to be matched is positioned adjacent the scanning bed of flatbed scanner 14. If the object is too large to fit entirely on the scanning bed, then the portion of the object having the desired color is positioned adjacent the scanning bed of flatbed scanner 14. Alternatively, if the object cannot be moved, for example because it is too heavy or is fixedly attached, then the scanner 14 may be moved to position the scanning bed adjacent the object. Of course, a digital camera or other handheld optical scanner device would be more suitable than the flatbed scanner 14 in this latter scenario.

Once the object (or portion thereof) and the scanning bed are positioned adjacent one another, the flatbed scanner 14 is actuated at step 30 to scan the object and to produce a color image data signal representative of the scanned object. The color image data signal may then be transferred to the computer system 10 so that an image 26 of the scanned object may be displayed on the monitor 16 at step 32. See FIG. 4.

It is generally preferred, but not required, that a color region 34 containing the color to be matched be selected at step 36. Computer readable program code may be provided that allows the user to select the color region 34 from the color image data signal. If so, the program code may be stored on a computer readable storage device (e.g., storage device 42 or memory 54) operatively associated with the apparatus 10. In the embodiment shown and described herein, program code is provided that presents the user with a display screen 58 on the monitor 16. See FIG. 4. The display screen 58 may, for example, display an image 26 of the object or portion thereof that was scanned and prompt the user to select the color region 34. The user may be able to select the color region 34 by creating a selection box 34 (shown in broken lines in FIG. 4) on the image 26 with an appropriate input device (e.g., mouse 37) associated with the computer system 10. Alternatively, other methods of selecting the color region 34 are possible. For example, the selection could be made by the user uttering a voiced response. In another alternative embodiment, the selection could be made by the apparatus 10 without any user intervention and without displaying the image 26 at step 32. In yet another alternative embodiment, the color region 34 may be selected on the object rather than from the color image data signal. For example, if the object is multicolored, the user may scan only the portion of the object having the color to be matched rather than scanning the entire object.

Regardless of how the color region 34 is selected, in the next step 38, the apparatus 10 maps the color image data signal to the defined color space to ascertain the corresponding color. When mapping the color image data signal, the apparatus 10 may use a color look-up table 60 and an averaging process to find the corresponding color for the color region 34.

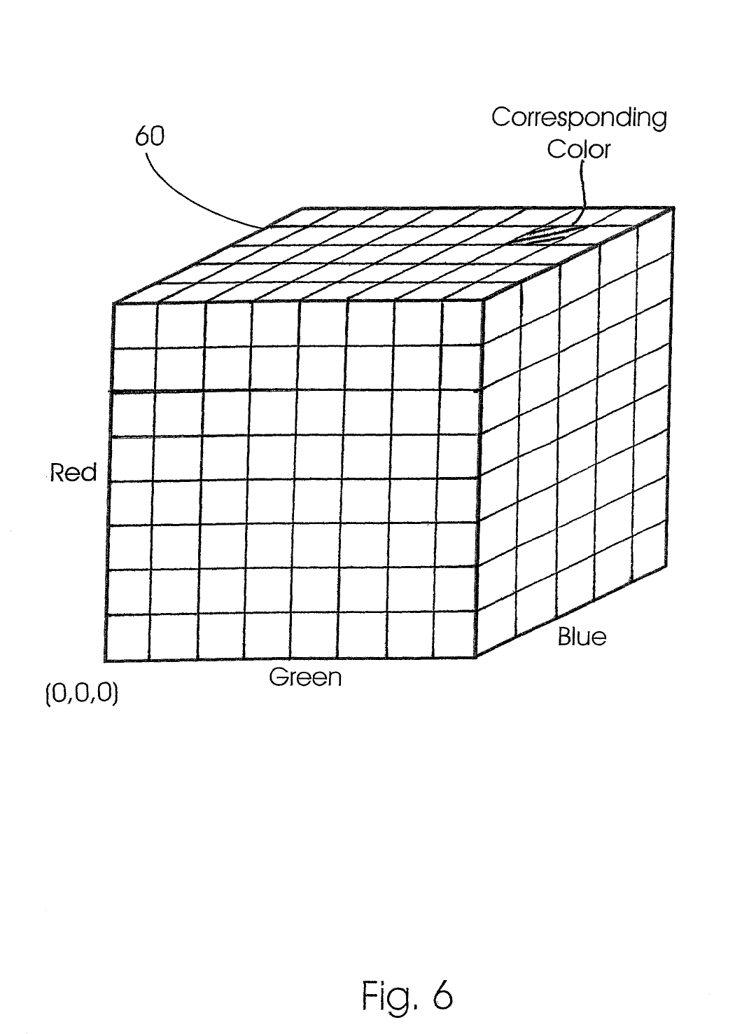

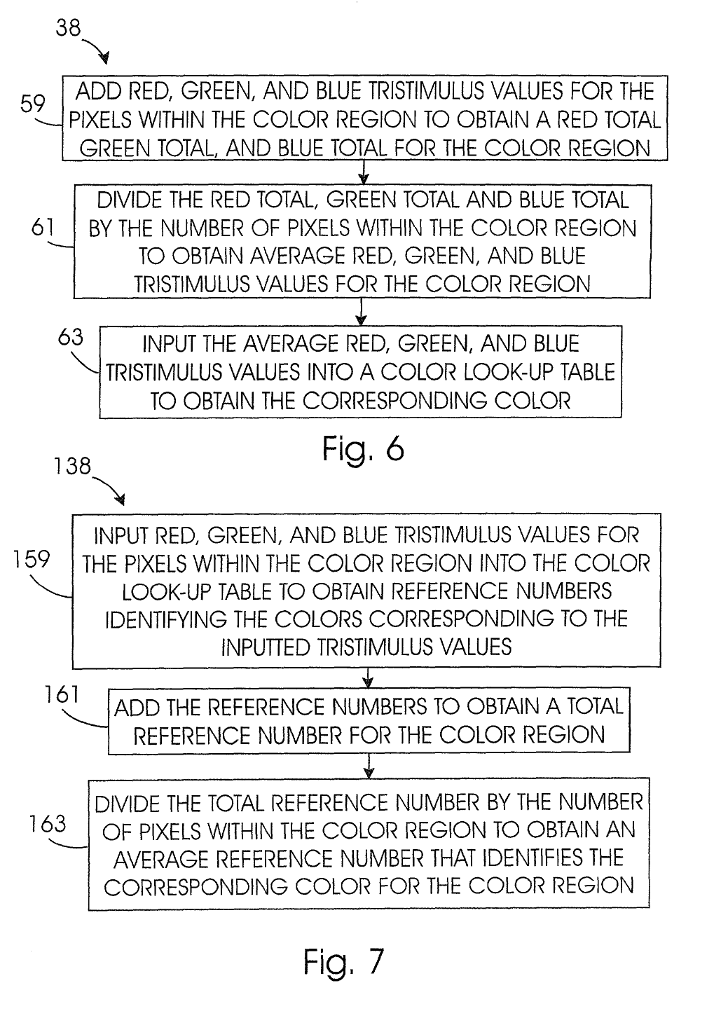

As shown in FIG. 6, the color look-up table 60 which may be used by the apparatus 10 may comprise a three dimensional matrix of data in which corresponding colors in the defined color space are assigned to the various combinations of tristimulus values. In other words, a corresponding color is assigned to a specific location having the coordinates r, g, b in the color look-up table 60 where r, g, b represent the respective tristimulus values for the corresponding color. Thus, the corresponding color in the defined color space that matches or corresponds with the color to be matched can be obtained by simply locating the color having the coordinates r, g, b (i.e., the tristimulus values for the color to be matched) in the color look-up table 60. Alternatively, reference numbers associated with the corresponding colors may be assigned to the various locations in the color look-up table 60.

The color look-up table 60 may be stored on a computer readable storage device (e.g., storage device 42 or memory 54) and may comprise the three-dimensional color look-up table represented schematically in FIG. 6. Alternatively, other storage locations, sizes and configurations are possible.

In the embodiment shown and described herein, the Pantone Matching System is used as the defined color space. The Pantone Matching System is a well-known color matching system that has a number assigned to over five hundred different colors and shades. Alternatively, any of a wide range of other suitable color spaces may be used in the present invention as would be obvious to persons having ordinary skill in the art after having become familiar with the teachings of the present invention.

Since the color region 34 will likely comprise a plurality of pixels of varying colors and shades, the apparatus 10 may perform an averaging process when mapping the color image data signal at step 38. For example, program code may be provided that computes an average red, average green, and average blue tristimulus value for the entire color region 34. See FIG. 7. In other words, the respective red, green and blue tristimulus values for each of the pixels within the color region 34 are first added together at step 59 with the resulting three totals (i.e., red total, green total, blue total) being divided by the total number of pixels within the color region 34 at step 61. The average red, green, and blue tristimulus values obtained in step 61 can then be inputted into the color look-up table 60 at step 63 to obtain the identity of the corresponding color. In an alternative embodiment 138, the program code may first input the respective tristimulus values for each pixel within color region 34 into the color look-up table 60 at step 159 to obtain reference numbers associated with the colors corresponding to the inputted tristimulus values. See FIG. 8. The program code would then compute an average reference number that identifies the corresponding color for the color region by first adding the reference numbers to obtain a total reference number (161) and then dividing that total reference number by the number of pixels within the color region 34 (step 163). Depending on the particular application, the user could be provided with the identity of the corresponding color and/or the average reference number associated therewith. In another alternative embodiment, the user may be prompted to select between the various colors comprising the color region 34. For example, the various colors of color region 34 may be displayed on the monitor 16 with the user selecting one of the various colors as the color to be matched, for example, by marking the desired color with an appropriate input device (e.g., mouse 37). Once marked, the portion of the color image data signal representative of the selected color would then be mapped by the apparatus 10 at step 38. In yet another alternative embodiment, program code could be provided that first determines which color contained within the color region 34 is dominant and then selects that dominant color as the color to be matched. To determine the dominant color within the color region 34, program code may be provided that analyzes the portion of the color image data signal representative of the color region 34 and then selects the color (i.e., the dominant color) that appears most often in color region 34. While conducting the analysis, three histograms may be created, one for each of the respective sets of tristimulus values (red, green and blue) for the pixels within color region 34. The three histograms may include horizontal or vertical bars, each having a length in proportion to the frequency in which the tristimulus value it represents appears in the color region 34. Since histograms are well-known in the art and could be easily provided by persons having ordinary skill in the art after having become familiar with the teachings of the present invention, the particular histograms utilized in one preferred embodiment of the invention will not be described in detail herein.

Rather than having the apparatus 10 use each and every pixel contained within the color region 34 when mapping the color image data signal, program code may be provided that randomly selects one or more of the pixels within color region 34. Alternatively, the individual pixels forming the color region 34 may be displayed on the monitor 16 so that the user is able to select one or more of the displayed pixels by simply marking the pixel(s) with an appropriate input device (e.g., mouse 37). Once marked, only that portion of the color image data signal representative of the selected pixel(s) would be mapped to the defined color space by the apparatus 10.

The color mapping step 38 of method 12 may also comprise the additional step of de-texturizing the color image data signal (not shown). Since the object may be textured (e.g., corduroy), it is generally preferred, but not required, that program code be provided to remove the influence of the texture from the color image data signal. De-texturizing the color image data signal reduces or eliminates the impact (e.g., shading, color variations) that the texture of the object may otherwise have on the color identification process and thereby tends to lead to more accurate results. To accomplish this de-texturizing process, program code, such as a Fast Fourier Transfer algorithm, may be provided that analyzes the portion of the color image data signal representative of the color region 34. While conducting the analysis, three histograms may be created, one for each of the respective sets of tristimulus values (red, green and blue) for the pixels within color region 34 which assist in the selection of the color (i.e., the dominant color) that appears most often in the color region 34. The three histograms may include horizontal or vertical bars, each having a length in proportion to the frequency in which the tristimulus value it represents appears in the color region 34. Since Fast Fourier Transfer algorithms and histograms are both well-known in the art and could be easily provided by persons having ordinary skill in the art after having become familiar with the teachings of the present invention, the particular histograms and Fast Fourier Transfer algorithm utilized in one preferred embodiment of the invention will not be described in detail herein.

In the last step 40 shown in FIG. 2, the user is informed of the identity of the corresponding color, for example, by being provided a reference number that is associated with and identifies the corresponding color. In the embodiment shown and described herein, the reference number and the color corresponding to that reference number are displayed on a display screen 62. See FIG. 5. Alternatively, other methods of presenting the corresponding color and/or reference number are possible. For example, the corresponding color and/or reference number could be printed out on the printer 18 that is connected to the computer system 10. Once printed, the user could take the printout to a store and obtain a product having the color corresponding to that reference number and corresponding color.

As mentioned above, the present invention also contemplates methods including more steps than what are shown in FIG. 2. For example, the method 12 may further include the additional step of using the corresponding color or the reference number associated therewith, which the user was previously provided with in step 40, to match a color with the color to be matched. Since the ways in which the corresponding color and reference number may be used to match colors are far too numerous to fully list herein, only a few examples will be given. For example, a customer may provide a vendor with the corresponding color or reference number so that the vendor can provide a product having the color that corresponds thereto. In other words, the corresponding color or reference number may be given to a vendor so that the vendor can custom make a product that matches the color of the object scanned with the scanner 14. The corresponding color or reference number could also be manually entered into the computer system 10 with the keyboard 22 when the customer is prompted to do so by an online shopping website so that it could be forwarded to an online vendor through the network 56. Alternatively, the online shopping website could be fully automated such that after the customer scans the object, the corresponding color or reference number is sent directly over the network 56 to the online vendor without any further customer intervention.

It is to be understood that the computer readable program code can be conventionally programmed using any of a wide range of suitable computer readable programming languages that are now known in the art or that may be developed in the future. It is also to be understood that the computer readable program code can include one or more functions, routines, subfunctions, and subroutines, and need not be combined in a single software package.

It is contemplated that the inventive concepts herein described may be variously otherwise embodied and it is intended that the appended claims be construed to include alternative embodiments of the invention except insofar as limited by the prior art.

What is claimed is:

1. A method for matching a color with a corresponding color in a defined color space, comprising:
scanning an object having the color to be matched to produce a color image data signal representative of said object;
mapping said color image data signal to the defined color space to ascertain the corresponding color; and
informing a user of the corresponding color.

2. The method of claim 1, further comprising, using said corresponding color to match a color with the color to be matched.

3. The method of claim 1, wherein the corresponding color has a reference number associated therewith, and wherein the step of informing a user of the corresponding color comprises the step of informing the user of the reference number associated with said corresponding color.

4. The method of claim 3, further comprising, using said reference number to match a color with the color to be matched.

5. The method of claim 3, further comprising, displaying said reference number.

6. The method of claim 1, further comprising, selecting a color region on said object, the color region containing said color to be matched.

7. The method of claim 1, further comprising, selecting a color region of said color image data signal, the color region containing said color to be matched.

8. The method of claim 1, wherein said object comprises a plurality of colors, and further comprising selecting one of said plurality of colors as said color to be matched.

9. The method of claim 1, wherein said object has a texture, and further comprising processing said color image data signal to remove the influence of said texture from the color image data signal.

10. The method of claim 1, wherein said defined color space comprises the Pantone Matching System.

11. The method of claim 1, wherein mapping said color image data signal to the defined color space to ascertain the corresponding color comprises using a color look-up table.

12. The method of claim 11, wherein said color image data signal comprises a plurality of pixels, each having a red tristimulus value, a green tristimulus value, and a blue tristimulus value associated therewith, and wherein mapping said color image data signal to the defined color space to ascertain the corresponding color further comprises:
computing an average red tristimulus value, an average green tristimulus value, and an average blue tristimulus value from the red, green and blue tristimulus values of one or more of said plurality of pixels; and
inputting the average red, green, and blue tristimulus values into said color look-up table to obtain the corresponding color.

13. The method of claim 11, wherein said color image data signal comprises a plurality of pixels, each having a red tristimulus value, a green tristimulus value, and a blue tristimulus value associated therewith, and wherein mapping said color image data signal to the defined color space to ascertain the corresponding color further comprises:
inputting the red, green and blue tristimulus values of one or more of said plurality of pixels into said color look-up table to obtain one or more reference numbers; and
computing an average reference number from said one or more reference numbers, the average reference number identifying said corresponding color.

14. A system for matching a color with a corresponding color in a defined color space, comprising:
scanning apparatus, said scanning apparatus scanning an object having the color to be matched, said scanner apparatus producing a color image data signal representative of said object; and
a computer operatively associated with said scanner apparatus, said computer mapping said color image data signal to the defined color space to ascertain the corresponding color, said computer informing a user of the corresponding color.

15. The system of claim 14, further comprising:
at least one computer readable storage device operatively associated with said computer; and
computer readable program code for selecting a color region of said color image data signal, the color region containing said color to be matched, the computer readable program code being stored on said at least one computer readable storage device.

16. The system of claim 15, wherein said computer readable program code further comprises program code for allowing a user to select said color region.

17. The system of claim 14, wherein said object has a plurality of colors, and further comprising:
at least one computer readable storage device operatively associated with said computer; and
computer readable program code for selecting one of the plurality of colors as said color to be matched, the computer readable program code being stored on said at least one computer readable storage device.

18. The system of claim 14, wherein said object has a texture, and further comprising,
at least one computer readable storage device operatively associated with said computer; and
computer readable program code for removing the influence of the texture from said color image data signal, the computer readable program code being stored on said at least one computer readable storage device.

19. The system of claim 14, further comprising:
at least one computer readable storage device operatively associated with said computer; and
a color look-up table stored on the at least one computer readable storage device, said computer using the color look-up table when mapping said color image data signal to the defined color space to ascertain the corresponding color.

20. The system of claim 14, wherein said defined color space comprises the Pantone Matching System.
